(19) United States
(12) Patent Application Publication
(10) Pub. No.: US 2008/0034053 A1
(43) Pub. Date: Feb. 7, 2008

(54) Mail Server Clustering

(75) Inventors: Michael Edward Dasenbrock, South Jordan, UT (US); Gregory Bjorn Vaughan, Santa Cruz, CA (US); Kazuhisa Yanagihara, Cupertino, CA (US)

Correspondence Address: FISH & RICHARDSON P.C., PO BOX 1022, MINNEAPOLIS, MN, 55440-1022, US

(73) Assignee: APPLE COMPUTER, INC., Cupertino, CA (US)

(21) Appl. No.: 11/462,584

(22) Filed: Aug. 4, 2006

(51) Int. Cl. G06F 15/16

(52) U.S. Cl. 709/210

(57) ABSTRACT

Multiple devices are automatically configured within a cluster through the use of exclusive file locks in a shared file system. The devices execute a process to determine the health of the enabled services and check for failed services. Actions are tailored based upon which services and roles are enabled for a specific device to maintain a relationship and sharing of information and data between the devices.

### TECHNICAL FIELD

The disclosed implementations relate to electronic devices.

### BACKGROUND

A cluster is a group computers that closely work together so that in many respects they can be viewed as though they are a single computer. Clusters are commonly, but not always, connected through fast local area networks and are deployed to improve speed and/or reliability over that provided by a single computer.

High-availability clusters are implemented to improve the availability of services which the cluster provides. They operate by having one or more redundant nodes, which are then used to provide service when system components fail. Load-balancing clusters operate by having all workload come through one or more load-balancing front ends, which then distribute the work to a collection of back-end servers. Although load balancing clusters are implemented primarily to improve performance, they commonly include high-availability features as well.

Typically, clusters are configured having one “master” server and multiple “slave” servers to distribute access to services. The master server is responsible for managing changes to configuration data, user data, etc., and propagating any changes to the slave servers. In conventional systems, if the master server should go offline for any reason or other wise by unable to provide services, the slave servers do not receive updates, thus preventing the services from operating correctly. To restore service capabilities, the master server needed to be brought back online or a new master needed to be manually created with all the slaved reconfigured with the new IP address of the new master server. This requires a significant amount of manual intervention and can lead to significant service downtime.

### SUMMARY

Disclosed herein are systems and methods for clustering devices.

In an exemplary implementation, a lock file or other resource in a file system is accessed by processes to establish an entity within a cluster of entities that is able to gain an exclusive lock on the lock file. The entity that has the exclusive lock is designated a master and other entities are designated slaves. Configuration information for services are shared among the entities, with the master maintaining the information and replicating it to the slaves. When the master goes offline a new master is designated after one of the remaining entities establishes a lock on the lock file and assumes the master role.

In another implementation, a system includes a plurality of devices each containing an engine that periodically checks lock files within a file system. As each device engine checks the lock files, if one or more of the lock files is found be in a condition where it lacks an exclusive lock, the device that discovers this condition assumes control of the lock file and its associated data to ensure the proper disposition of the associated data.

In another implementation, a system includes a plurality of devices that are configured in a cluster. An engine within each device attempts to lock file in a file system to establish a master device that will share information with slave devices. If the master device goes offline, a new master is designated after one of the remaining devices establishes a lock on the lock file and assumes the master role.

These and other implementations are described in detail below.

### DESCRIPTION OF DRAWINGS

FIG. 1 is an overview of an exemplary network implementation.

FIGS. 2-4 are exemplary processes performed to manage entities.

FIG. 5 is an exemplary device implementation.

Like reference symbols in the various drawings indicate like elements.

### DETAILED DESCRIPTION

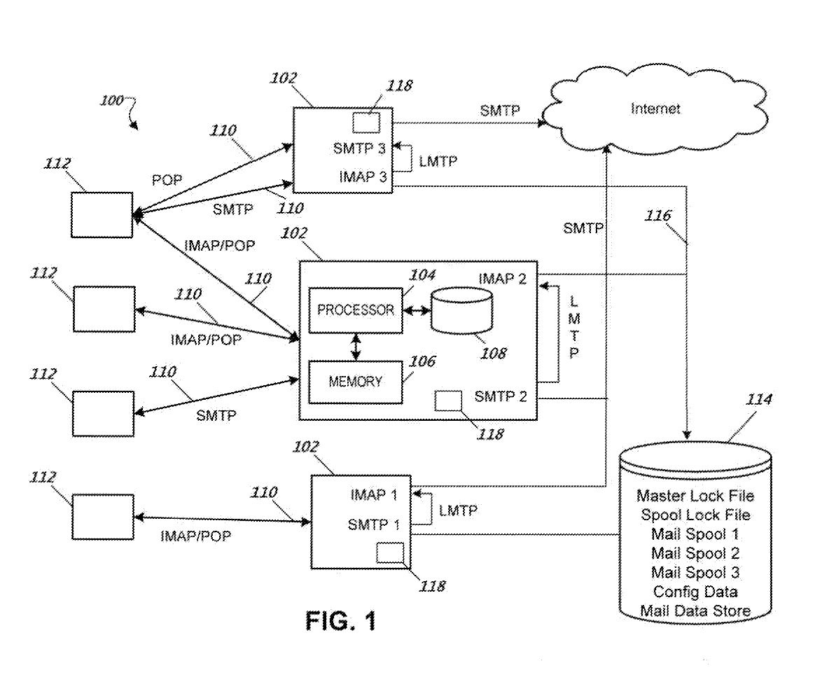

FIG. 1 is an example system 100 in which the systems and methods disclosed herein may be implemented. The exemplary system 100 includes multiple servers 102, network connections 110, and multiple clients 112. One or more of the servers 102 can include a processor 104 coupled to a computer readable memory 106, such as a RAM or other data store. Each server 102 can also include another data store 108, such as a database. Each server 102 can include program instructions executable by the processor 104 to implement services. User data, attribute data, computer data, etc., can be stored in the memory 106 and data store 108.

The servers 102 communicate with the clients 112 via the network connections 110. The network 110 may be a local area network (LAN), wireless LAN, or a wide area network (WAN), such as the Internet. Each client 112 may be associated with one or more users, and may comprise a device capable of communicating over the network 110, such as a computer, a mobile communication device, other communication device or other device. The servers 102 are connected to a file system 114 using for example a high speed network 116. The file system 114 can be a storage area network, such as Xsan available from Apple Computer, Inc., and the high speed network can be a Fibre Channel network. Though a client-server configuration is shown, other system configurations are possible including those for provisioning various electronic devices including mobile telephones, personal digital assistants, mobile electronic devices, game consoles, set top boxes, etc.

In FIG. 1, one or more servers 102 may be configured as a mail server. In one implementation, the mail server is configured as an Internet Message Access Protocol (IMAP) server and a Simple mail Transfer Protocol (SMTP) server. Further, the mail servers can be clustered to improve availability, performance, etc. In one implementation, the cluster has one “master” server (e.g., IMAP 1) and multiple “slave” servers (e.g., IMAP 2 and IMAP 3) to distribute access to user mail accounts. In one implementation, user connect to their mail accounts using a client application on a client 112 and an IMAP or Post Office Protocol (POP) connection to a server 102. In one implementation, the servers 102 are running Cyrus IMAP mail server (e.g., cyrus-imapd-2.3.3 or greater).

In one implementation, each server 102 executes a process 118 (e.g., a Mail Cluster Manager (MCM)) to handle the event of a Master server crashing. Alternatively, one ore more of the servers 102 (but not all), can execute process 118. The process 118 enables mail services and selects master and slave servers. The process 118 detects the master server going offline and reconfigures one of the existing slave servers to become the new master, as well as reconfiguring the remaining slave servers with the new master's configuration information without requiring user intervention, as described below.

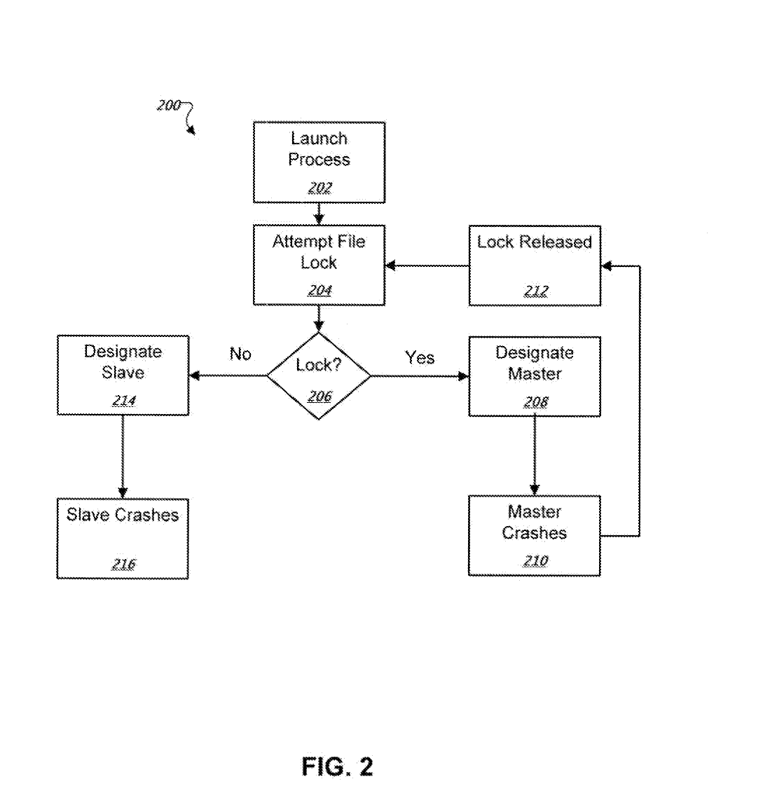

Referring now to FIG. 2, there is illustrated exemplary processes 200 to manage a cluster. At step 202, a process is launched. For example, when each server 102 is started, the process 118 is launched. At step 204, a file lock is attempted. In one implementation, the process 118 attempts to gain a lock in a predefined area of other resource (e.g., a master lock file) on the mounted file system 114. Lock files are used to signal that some resources is in a locked condition. At step 206, it is determined if a lock is achieved, and at step 208, a master is designated for a cluster based on the lock condition. In one implementation, the server 102 having a process 118 that first achieves an exclusive lock on the master lock file in the file system 114 is designated the master server (e.g., IMAP 1), and then configured by the process 118 to perform master operations such as maintaining configuration files and data and replicating this information to other servers.

If at step 206 a lock is not achieved, the process continues to step 214, where slaves in the cluster are designated. In the example above, IMAP 1 is designated the master. Because the process 118 running on IMAP 1 will hold the lock, the processes 118 running on the other servers 102 (e.g., IMAP 2 and IMAP 3) will fail to lock on the master lock file in the file system 114. The process 118 running on the servers IMAP 2 and IMAP 3 will block and the severs IMAP 2 and IMAP 3 will be configured as slaves by the process 118.

AT step 210, a crash of the master occurs or the master is otherwise unable to process service requests (e.g., IMAP 1 goes offline or a processing error arises). If the crash/processing error occurs, the lock is released at step 212 and the process 200 returns to step 204 where a file lock is attempted to designate a new master. In one implementation, the processes 118 on the slave servers IMAP 2 and IMAP 3 will awake when the lock from IMAP 1 is released as the processes 118 are no longer blocked. In one implementation, each of processes 118 running on the slaves will attempt to gain an exclusive lock on the “masters” lock file in the file system 114. Alternatively, a designated one of the slaves will attempt to gain the exclusive lock. At a predetermined time later, one or more additional slaves can attempt to gain the exclusive lock. At step 206, it is determined which process 118 gained a lock, and at step 208, a new master is designated. As noted above, the server having a process 118 that first gains the exclusive lock will become the new master (e.g., IMAP 2). Steps 204-212 may be repeated as necessary to maintain the existence of a master.

At step 216, a crash/processing error of a salve occurs. Here, no action is necessary by the processes 118 running on the master server of any other slave server.

In one implementation, the processes 118 are responsible for managing mail data queues for SMTP servers. In one implementation, each server 102 within a mail cluster will have at least one primary SMTP Spool to handle mail transfer for that server. The mail spools can be stored in the file system 114. The servers can also have secondary SMTP spools which will be responsible for mail delivery only. The failure of an SMTP server can result in an orphaned mail spool. There can be undelivered mail contained within the orphaned spool and it is generally not acceptable to leave mail undelivered. In the event of a server crash or other processing error, any other SMTP server within the cluster can gain ownership of the crashed-server's mail spool to complete the delivery of any mail within the spool. In one implementation, Postfix is used as the Mail Transfer Agent to communicate email messages to and from SMTP servers. In another implementation, local mail delivery is handled via the Local Mail Transfer Protocol (LMTP).

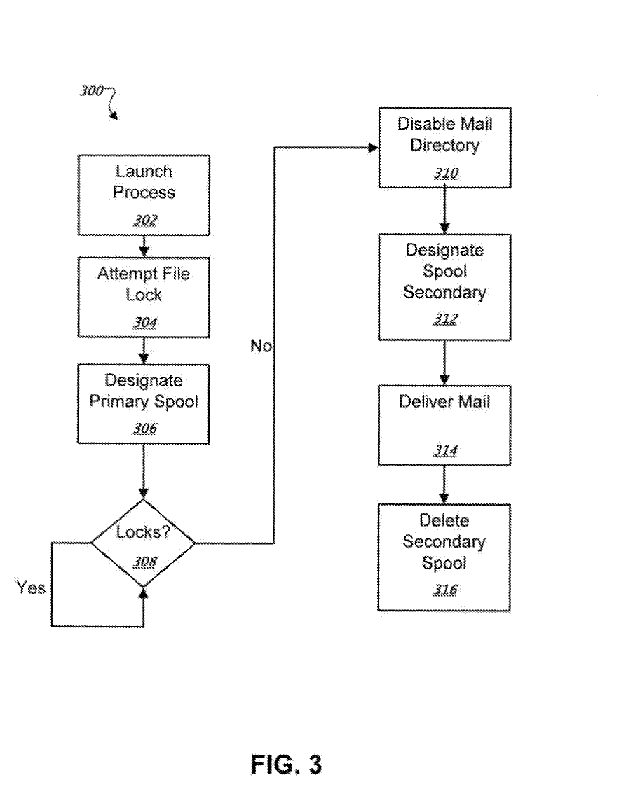

Referring now to FIG. 3, there is illustrated exemplary processes 300 to manage a cluster. At step 302, a process is started. At step 304, a file lock is attempted. For example, the process 118 on each server 102 will attempt to gain an exclusive lock on a spool lock file mounted in the file system 114. At step 306, a primary spool is designated. In one implementation, when an exclusive lock is obtained on the spool lock file, the process 118 will make the associate mail spool (e.g., Mail Spool 1) the primary spool for that server (e.g. SMTP 1). This primary spool will allow inbound and outbound mail delivery.

At step 308, a check is performed of the spool lock files for exclusive locks. For example, the process 118 running one or more (or in one implementation each) server 102 can periodically check each spool lock file within the file system 114 for exclusive locks. If an exclusive lock is found on the spool lock files, then the process loops. If a process 118 finds a spool lock file without an exclusive lock, that will indicate that the previous SMTP owner-server is no longer online or otherwise not capable of delivering mail for that spool.

If a spool lock file lacks an exclusive lock, then at step 310, a mail directory is disabled (e.g., the maildrop directory within the mail spool associated with the spool lock file found to lack an exclusive lock will be disabled to prevent any new mail from being posted to the spool). At step 312, the mail spool discovered at step 308 is designated a secondary mail spool (e.g., by the discovering process 118). At step 314, undelivered mail within the secondary mail spool is delivered. At step 316, the secondary mail spool can optionally be deleted after all mail has been delivered and the associated spool lock file can be removed.

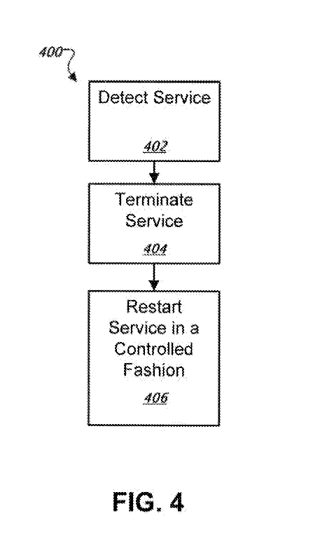

In another implementation, the process 118 detects mail services which may have been launched manually or outside administrative control, terminates these services and restarts them, if necessary. For example, mail services can launched manually using the command line, and because of this they may not have been started with the correct configuration options. Referring to FIG. 4, there is a flow chart of exemplary processes 400 performed to detect services. As step 402, a service is detected. For example, the process 118 will detect a mail service that has not been launched under its control. At step 404, the service is terminated. At step 406, the service is re-launched in a controlled setting (e.g., process 118 will assume control of the restarted mail service).

Through the use of the shared file system 114, processes 118 and exclusive file locks, the servers 102 within a cluster can be automatically monitored and reconfigured without manual intervention. The processes 118 perform periodic tasks to monitor the health of the enabled services and check for failed services. Actions may be tailored based upon which mail services are enabled for a specific server.

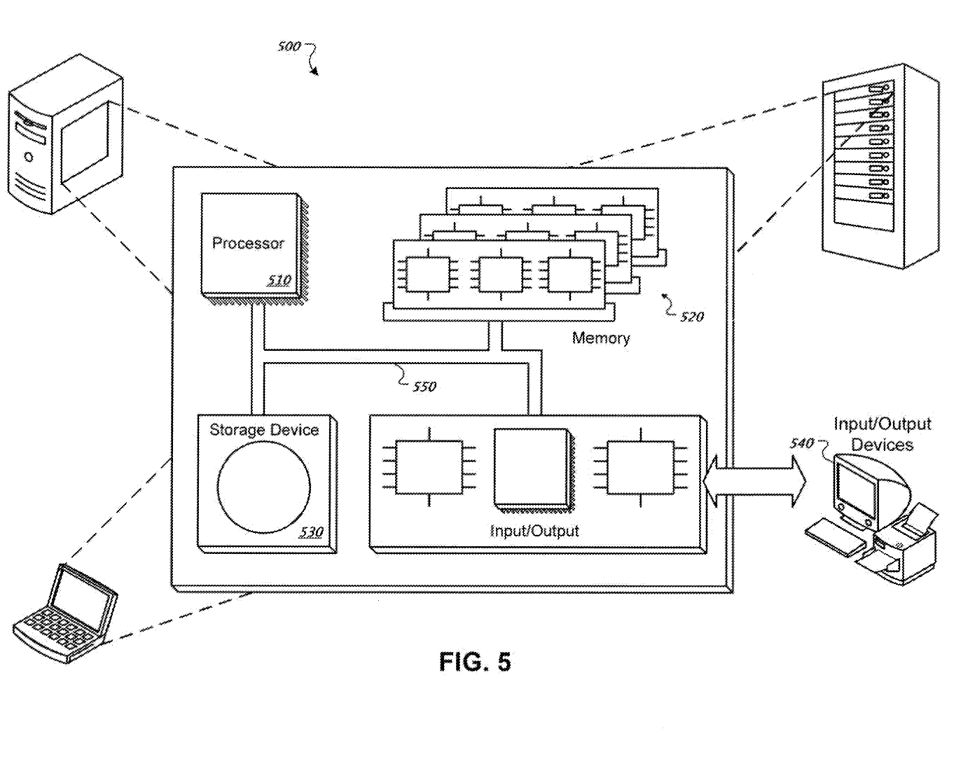

FIG. 5 is a block diagram illustrating an exemplary device environment 500. The system can be used for the operations described above according to one implementation. The system 500 includes a processor 510, a memory 520, a storage device 530, and an input/output device 540. Each of the components 510, 520, 530, and 540 are interconnected using a system bus 550. The processor 510 is capable of processing instructions for execution within the system 500. In one embodiment, the processor 510 is a single-threaded processor. In another embodiment, the processor 510 is a multi-threaded processor. The processor 510 is capable of processing instructions stored in the memory 520 or on the storage device 530 to display graphical information for a suer interface on the input/output device 540.

The memory 520 stores information within the system 500. In one embodiment, the memory 520 is a computer-readable medium. In one embodiment, the memory 520 is a volatile memory unit. In another embodiment, the memory 520 is a non-volatile memory unit.

The storage device 530 is capable of providing mass storage for the system 500. In one embodiment, the storage device 530 is a computer-readable medium. In various different embodiments, the storage device 530 may be a floppy disk device, a hard disk device, an optical disk device, or a tape device.

The input/output device 540 provides input/output operations for the system 500. In one embodiment, the input/output device 540 includes a keyboard and/or pointing device. In one embodiment, the input/output device 540 includes a display unit for displaying graphical user interfaces.

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other. Other computer or device system configuration are possible.

A number of embodiments of the invention have been described. Nevertheless, it will be understood that various modifications may be made without departing from the spirit and scope of the invention. For example, Post Office Protocol (POP) servers can be monitored similarly as IMAP servers. Accordingly, other embodiments are within the scope of the following claims.

What is claimed is:

1. A method, comprising:
initiating a lock on a resource by each of a plural entities;
identifying if the lock on the resource by each entity is successful; and
applying a first attribute or a second attribute to each entity in accordance with a success or failure of the lock.

2. The method of claim 1, further comprising:
determining if the lock has been released by a first entity of the plural entities having the first attribute;
reinitiating the lock on the resource by one or more of the plural entities;
determining a second entity of the plural entities that successfully achieved the lock on the resource; and
applying the first attribute to the second entity.

3. The method of claim 2, further comprising:
disabling an operation of the first entity;
assigning the operation to the second entity; and
completing the operation by the second entity.

4. The method of claim 2, further comprising:
managing mail services for the plural entities.

5. The method of claim 4, further comprising:
maintaining a database of mailbox information at the first entity;
replicating the database of mailbox information to others of the plural entities; and
transferring the database of mailbox information to the second entity when the lock has been released by the first entity.

6. The method of claim 4, further comprising:
managing a queue by the first entity; and
transferring the queue to the second entity when the lock has been released by the first entity.

7. The method of claim 1, further comprising:
sharing configuration information between the plural entities.

8. The method of claim 7, further comprising:
maintaining the configuration information at the first entity; and
replicating the configuration information to others of the plural entities.

9. The method of claim 8, further comprising:
sharing the configuration information in a common file system.

10. A system, comprising:
a plurality of devices;
a management engine executing on each of the plurality of devices; and
a common file system shared by the plurality of devices,
wherein one of the plurality of devices is designated a master device and the others of the plurality of devices are designated salve devices in accordance with a state of a lock file within the common file system, and wherein the management engine automatically configures the master device and slave devices.

11. The system of claim 10, wherein the management engine determines if the lock has been released by the master device.

12. The system of claim 11, wherein the management engine reinitiates the lock on the lock file by each of the plurality of device and identifies if the lock by each of the plurality of devices on the lock file is successful, and wherein the management engine determines a new master device in accordance with a success or failure of the lock.

13. The system of claim 10, further comprising program instructions that upon execution of the management engine cause the system to:
maintain a database of mailbox information in the common file system by the master device;
replicate the database of mailbox information to the slave devices; and
transfer the database of mailbox information to a new master device when the lock has been released by the master device.

14. The system of claim 10, further comprising program instructions that upon execution of the management engine cause the system to:
manage a message queue in the common file system by the master device; and
transfer the message queue to a new master device when the lock has been released by the master device.

15. The system of claim 10, further comprising program instructions that upon execution of the management engine cause the system to:
determine if one of the plurality of devices is running a service that is not managed by the management engine;
terminate the service that is not managed by the management engine; and
restart the service as managed by the management engine.

16. A computer-implemented method, comprising:
locking a resource by plural entities;
determining if a lock of the resource was successful for each entity of the plural entities;
designating a status of each entity in accordance with the lock; and
coordinating information among the plural entities based on the status of each entity.

17. The computer-implemented method of claim 16, further comprising:
designating a first status where the lock was successful;
designating a second status where the lock was not successful;
maintaining the information at the entity having the first status; and
replicating the information to entities having the second status.

18. The computer-implemented method of claim 16, wherein the information being maintained is mailbox data.

19. The computer-implemented method of claim 16, wherein the information being maintained is mail message data.

20. A system, comprising:
means for initiating a lock on a resource by each of plural entities;
means for identifying if the lock on the resource by each of the plural entities is successful; and
determining an attribute of the each of the plural entities in accordance with a success or failure of the lack.
